(19) United States
(12) Patent Application Publication
(10) Pub. No.: US 2006/0189754 A1
(43) Pub. Date: Aug. 24, 2006

(54) Method of making a composition

(76) Inventors: Toprak F. Serhatkulu, Grosse Ile, MI (US); Armando A. Sardanopoli, Grosse Ile, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/060,954

(22) Filed: Feb. 18, 2005

(51) Int. Cl. C08L 51/00

(52) U.S. Cl. 525/64

(57) ABSTRACT

A composition includes thermoplastic polyurethane (TPU) and methyl methacrylate-acrylonitrile-butadiene-styrene (MABS) graft copolymer. The TPU is present in an amount of greater than 40 parts by weight, and the MABS graft copolymer is present in an amount of from 1 to 50 parts by weight, both based on the total weight of the composition. The composition has a light transmission value of at least 40%, as measured in accordance with ASTM D-1003, and a coefficient of friction of less than 1.5. The composition including the TPU and the MABS graft copolymer in the above weight ranges has good transparency, elongation, tensile strength, tear strength, elasticity, chemical resistance, and abrasion resistance that are all associated with the TPU. The presence of the MABS graft copolymer in the composition lowers the coefficient of friction of the TPU and while still substantially maintaining the light transmission value of the TPU, making the composition useful in many applications, especially in the pipeline repair industry.

### FIELD OF THE INVENTION

The present invention generally relates to a composition including thermoplastic polyurethane, a method of making the composition, and an article including the composition. More specifically, the subject invention relates to a composition including thermoplastic polyurethane and a copolymer for improving certain properties of the composition.

### BACKGROUND OF THE INVENTION

Thermoplastic polyurethanes (TPUs) are generally known in the art for use in many applications including molded products, extruded products, and packaging materials. TPUs have superior properties, as compared to many other polymers such as polyethylene, including good elongation, tensile strength, tear strength, elasticity, chemical resistance, and abrasion resistance. The superior properties of the TPUs make the TPUs preferred over the other polymers for many applications. Further, the TPUs also exhibit good transparency, e.g., a light transmission value of at least 40% as measured in accordance with ASTM D-1003. When used in packaging materials, the good transparency of the TPU allows visual inspection of the contents of the packaging materials.

Although the TPUs have many good physical properties, the TPUs have other properties that render them unsuitable for some applications. For example, TPUs tend to have a tacky surface texture, i.e., a high coefficient of friction of greater than 2.0, and may, as a result, be difficult to handle.

Copolymers have been added to the TPUs to improve certain properties of the TPU. For example, U.S. Pat. No. 5,973,074 discloses that mixtures of TPU and copolymers, such as ABS, have long been available. One of the problems with the mixtures of ABS and the TPU is poor transparency, which is undesirable for many applications.

In the pipeline repair industry, a sleeve formed from a polymer having good transparency is employed. More specifically, the sleeve is either disposed on an inner surface of a fabric liner or inserted into the fabric liner after the fabric liner is in the pipeline. To get the fabric liner and/or the sleeve into the pipeline, an eversion process is generally used. The eversion process requires the sleeve to slide against itself, which in turn requires the sleeve to have a low coefficient of friction of less than 1.5 to facilitate sliding. After the sleeve is in the fabric liner, a camera may be inserted into the sleeve to observe the fabric liner through the sleeve. As such, the sleeve must have good transparency, i.e. contact clarity.

The sleeve can be formed from a polyethylene, since the polyethylene has sufficient transparency and a sufficiently low coefficient of friction, which results in little resistance to sliding during the eversion process. Due to poor elasticity, tensile strength, tear strength, chemical resistance, and abrasion resistance of the polyethylene, TPU has been used in place of the polyethylene. However, the coefficient of friction of the TPU alone is too high, and the addition of ABS results in transparency that is too poor for observing the fabric liner through the sleeve. Lubricants or fillers are presently used to lower the coefficient of friction of the TPU; however, the lubricants dramatically increase the cost of the TPU and the fillers dramatically decrease the transparency of the TPU below acceptable levels.

It is known to include TPU in a methyl methacrylate-acrylonitrile-butadiene-styrene (MABS) composition in order to reduce static electricity buildup in the MABS composition. More specifically, U.S. Pat. No. 5,614,589 discloses such a composition, which is used in the packaging industry for packaging electronic products. The composition includes an MABS graft copolymer in an amount of from 40 to 90 parts by weight based on the total weight of the composition, and the TPU is present in an amount of from 10 to 40 parts by weight based on the total weight of the composition. The composition is too rigid and includes an insufficient amount of TPU for many applications that require good elongation and elasticity. More specifically, the MABS graft copolymer has a glass transition temperature of about 220° F., whereas the TPU has a glass transition temperature that is below room temperature, i.e., about 30° F.

Thus, it would be desirable to provide a composition that has the good transparency, elongation, tensile strength, tear strength, elasticity, chemical resistance, and abrasion resistance that is associated with the TPU, without the high coefficient of friction of TPU and without the high costs of adding lubricants to the TPU. Such a composition would have applicability in many industries, in addition to the pipeline repair industry.

### SUMMARY OF THE INVENTION AND ADVANTAGES

The subject invention provides a composition and a method of making the composition. The composition includes thermoplastic polyurethane (TPU) and methyl methacrylate-acrylonitrile-butadiene-styrene (MABS) graft copolymer. The TPU is present in an amount of greater than 40 parts by weight based on the total weight of the composition, and the MABS graft copolymer is present in an amount of from 1 to 50 parts by weight based on the total weight of the composition.

The method of making the composition includes feeding the TPU and the MABS graft copolymer into a compounding device in the above-stated amounts. The TPU and the MABS graft copolymer are heated and mixed in the compounding device to produce the composition.

The subject invention further includes an article including a first layer including an impregnable material and a second layer disposed upon the first layer. The second layer has a light transmission value of at least 40%, as measured in accordance with ASTM D-1003, and a coefficient of friction of less than 1.5. The second layer includes the TPU and a copolymer including styrene for reducing the coefficient of friction of the TPU.

The composition including the TPU and the MABS graft copolymer in the above weight ranges has good transparency, elongation, tensile strength, tear strength, elasticity, chemical resistance, and abrasion resistance that are all associated with the TPU. The presence of the MABS graft copolymer in the composition lowers the coefficient of friction of the TPU and substantially maintains the light transmission value of the TPU.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a sleeve formed from the composition of the subject invention;

FIG. 2 is a partially cross-sectional side view of an article of the subject invention including a first layer and a second layer; and

FIG. 3 is a partially cross-sectional perspective view of the sleeve of FIG. 1 coating a substrate, such as a cable.

### DETAILED DESCRIPTION OF A PREFERRED EMBODIMENT

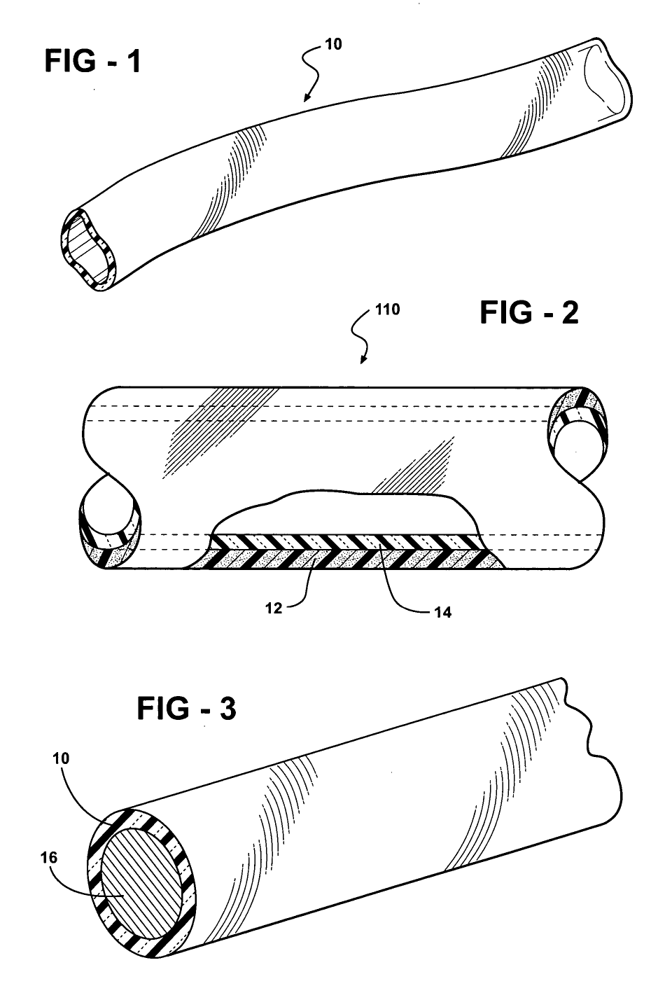

A composition of the subject invention includes thermoplastic polyurethane (TPU) and methyl methacrylate-acrylonitrile-butadiene-styrene (MABS) graft copolymer. The composition is useful in many industries, including the pipeline repair industry, packaging industry, and coating industry. For example, the composition may be used to form a sleeve 10, as shown in FIG. 1. In the pipeline repair industry, a liner formed from an impregnable material may be soaked with a monomer, such as styrene or epoxy, and inserted into a pipeline. The sleeve 10 may be inserted into the liner in the pipeline. Hot water or steam is passed through the sleeve 10 to expand the sleeve 10, and thus the liner, in the pipeline and to cure the monomer in the liner. In the coating industry, the sleeve 10 may be used to coat a substrate 16, e.g. a rod, cable etc., as shown in FIG. 3, to protect the substrate 16. Preferably, the sleeve 10 is from 0.001 to 0.150 inches thick.

In another embodiment of the subject invention, shown in FIG. 2, an article 110 may be formed including a first layer 12 and a second layer 14. The first layer 12 includes the impregnable material. The impregnable material may be selected from the group of, but is not limited to, fabric, foam, and combinations thereof. When used, the fabric preferably includes non-woven fabric, such as felt, for maximizing absorption capabilities of the fabric. However, it is to be appreciated that woven fabric may also be suitable for purposes of the subject invention. Furthermore, the fabric may include any variety of fibers, such as synthetic fibers and natural fibers. Specific examples of fibers suitable for the subject invention may be selected from the group of pulp fiber, hemp, cotton, polyethylene fiber, polypropylene fiber, rayon fiber, nylon fiber, polyester fiber, and combinations thereof. Preferably, the first layer 12 has a thickness of from 0.1 to 0.5 inches, most preferably about 0.25 inches. Articles including first layers, as described above, and second layers are well known in the art for use in the pipeline repair industry.

The second layer 14 is disposed upon the first layer 12 and is substantially impermeable to moisture. The second layer 14 includes the TPU and a copolymer including styrene for reducing the coefficient of friction of the TPU while substantially maintaining the light transmission value of the TPU, as discussed in further detail below. In a preferred embodiment, the second layer 14 includes the composition of the subject invention, which includes the TPU and the MABS graft copolymer. Although the MABS graft copolymer is the preferred copolymer, it is to be appreciated that other copolymers, such as styrenated acrylonitrile (SAN), may also be suitable for inclusion in the second layer 14, subject to preferred light transmission values and coefficients of friction of the composition including the TPU and the copolymer, which are discussed below. Preferably, the second layer 14 has a thickness of from 0.001 to 0.150 inches to be sufficiently impermeable to moisture.

Like the sleeve 10 of FIG. 1 and as alluded to above, the article 110 including the first layer 12 and the second layer 14 may also be used in the pipeline repair industry. For example, instead of inserting a liner and a separate sleeve 10 into the pipeline, the article 110 including the first layer 12 and the second layer 14 may be formed into a tubular shape, through methods known in the art, and inserted into the pipeline. The first layer 12 performs the function of the liner and the second layer 14 performs the function of the sleeve 10, both of which were discussed above.

The TPU may be selected from the group of polyester-based TPUs, polyether-based TPUs, and combinations thereof. The polyester-based TPUs include the reaction product of a polyester polyol and a diisocyanate. Polyester polyols suitable for producing the polyester-based TPUs may be produced from the reaction of a dicarboxylic acid and a glycol having at least one primary hydroxyl group. Dicarboxylic acids that are suitable for producing the polyester polyols may be selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols that are suitable for producing the polyester polyols may be selected from the group of, but are not limited to, ethylene glycol, butylene glycol, hexanediol, bis(hydroxymethylcyclohexane), 1,4-butanediol, diethylene glycol, 2,2-dimethyl propylene glycol, 1,3-propylene glycol, and combinations thereof.

Diisocyanates that are suitable for producing the polyester-based TPUs may be selected from the group of, but are not limited to, 4,4′-diphenylmethane diisocyanate, 2,4′-diphenylmethane diisocyanate, ethylene diisocyanate, ethylidene diisocyanate, propylene diisocyanate, butylene diisocyanate, cyclopentylene-1,3-diisocyanate, cyclohexylene-1,4-diisocyanate, cyclohexylene-1,2-diisocyanate, 2,4-toluylene diisocyanate, 2,6-toluylene diisocyanate, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, tetramethylene diisocyanate, pentamethylene diisocyanate, hexamethylene diisocyanate, 1-chlorobenzene-2,4-diisocyanate, furfurylidene diisocyanate, and combinations thereof.

In addition, the polyester-based TPUs may also include the reaction product of a suitable chain extender. Suitable chain extenders may be selected from the group of, but are not limited to, diols including ethylene glycol, propylene glycol, butylene glycol, 1,4-butanediol, butenediol, butynediol, xylylene glycols, amylene glycols, 1,4-phenylene-bis-.beta.-hydroxy ethyl ether, 1,3-phenylene-bis-.beta.-hydroxy ethyl ether, bis-(hydroxy-methyl-cyclohexane), hexanediol, thiodiglycol and the like; diamines including ethylene diamine, propylene diamine, butylene diamine, hexamethylene diamine, cyclohexalene diamine, phenylene diamine, tolylene diamine, xylylene diamine, 3,3′-dichlorobenzidine, 3,3′-dinitrobenzidine and the like; alkanol amines such as, for example, ethanol amine, aminopropyl alcohol, 2,2-dimethyl propanol amine, 3-aminocyclohexyl alcohol, p-aminobenzyl alcohol, and combinations thereof. Specific examples of polyester-based TPUs suitable for the subject invention include Elastollan® 600 and 800 Series polyester-based TPUs commercially available from BASF Corporation of Wyandotte, Mich.

The polyether-based TPUs include the reaction product of a polyether polyol and the diisocyanate. Suitable diisocyanates include any of those as mentioned above as suitable for producing the polyester-based TPUs. Polyether polyols suitable for producing the polyether-based TPUs may be selected from the group of, but are not limited to, polytetramethylene glycol, polyethylene glycol, polypropylene glycol, and combinations thereof. Like the polyester-based TPUs, the polyether-based TPUs may also include the reaction product of a suitable chain extender, and the chain extenders set forth above are also suitable for producing the polyether-based TPUs. Specific examples of suitable polyether-based TPUs suitable for the subject invention include Elastollan® 1100 Series polyether-based TPUs commercially available from BASF Corporation of Wyandotte, Mich.

The TPU is present in the composition in an amount of greater than 40 parts by weight, based on the total weight of the composition. More preferably, the TPU is present in an amount of from 75 to 94 parts by weight, most preferably about 80 parts by weight, based on the total weight of the composition. Compositions including the TPU in the above weight ranges exhibit the properties that are associated with the TPU, as opposed to properties of compositions including primarily MABS graft copolymer, such as good transparency, elongation, tensile strength, tear strength, elasticity, chemical resistance, and abrasion resistance.

Preferably, the MABS graft copolymer includes a copolymer of methyl methacrylate (MMA), a styrene-acrylonitrile polymer, and a styrene butadiene rubber grafted with MMA. The MABS graft copolymer optionally includes styrene.

The MMA may be a homopolymer of MMA or a MMA copolymer of MMA with an alkyl acrylate having from 1 to 8 carbon atoms in the alkyl radical. The alkyl acrylate may be present in an amount of from 0.5 to 10 parts by weight, more preferably about 7.0 parts by weight, based on the total weight of the MMA copolymer. Examples of such acrylates include ethyl acrylate, propyl acrylate, and butyl acrylate. Preferably, the MMA has a weight average molecular weight of at least about 60,000 and up to about 300,000 as measured by light scattering in chloroform.

The styrene-acrylonitrile polymer may be a copolymer including styrene in an amount of from 78 to 88 parts by weight and acrylonitrile in an amount of from 12 to 22 parts by weight, based on the total weight of the styrene-acrylonitrile polymer. Preferably, the styrene-acrylonitrile polymer has a weight average molecular weight of from 60,000 to 300,000, as determined by light scattering in dimethylformamide.

Preferably, the styrene butadiene rubber grafted with MMA (the “grafted rubber”) has a glass transition temperature of up to about −20° C. The grafted rubber may include butadiene rubber in an amount of from 50 to 80 parts by weight based on the total weight of the grafted rubber, with the balance of the weight of the grafted rubber being styrene and MMA. Such graft rubbers are known in the art for including in the MABS copolymer.

The butadiene rubber may be the reaction product of from 60 to 90 parts by weight of butadiene, isoprene, and combinations thereof, with the balance being styrene or alkyl styrene monomers.

Preferably, the MMA is present in the MABS graft copolymer in an amount of from 15 to 70 parts by weight, more preferably from 30 to 60 parts by weight, based on the total weight of the MABS graft copolymer. Preferably, the styrene-acrylonitrile polymer is present in the MABS graft copolymer in an amount of from 10 to 50 parts by weight, more preferably from 10 to 40 parts by weight, based on the total weight of the MABS graft copolymer. Preferably, the styrene-butadiene rubber grafted with MMA is present in the MABS graft polymer in an amount of from 20 to 50 parts by weight, more preferably from 25 to 40 parts by weight, based on the total weight of the MABS graft copolymer. It will be appreciated that each of the foregoing weight percent limitations may be employed alone or in combination with other weight percent limitations. Specific examples of suitable MABS graft copolymers suitable for the subject invention include Terlux® 2802 TR and Terlux® 2812 TR, both of which are commercially available from BASF Corporation of Wyandotte, Mich.

Preferably, the MABS graft copolymer is present in the composition, along with the TPU, in an amount of from 1 to 50 parts by weight, more preferably from 5 to 40 parts by weight, and most preferably from 15 to 25 parts by weight, based on the total weight of the composition. Compositions that include the MABS graft copolymer in the above weight ranges, in combination with the TPU in the previously stated weight ranges, lowers the coefficient of friction of the composition while still substantially maintaining the light transmission values of the TPU.

In addition to the MABS graft copolymer, the composition of the subject invention may further include additives selected from the group of plasticizers, lubricants, fire retardants, fillers, fibers, stabilizers, and combinations thereof. Specific examples of lubricants that may be suitable for the subject invention include ethylene bis stearamides. When present, the lubricant is included in the composition in an amount of from 0.05 to 1 parts by weight based on the total weight of the composition. Most preferably, the lubricant is included in the TPU prior to production of the composition of the subject invention.

As alluded to above, the composition of the subject invention, as well as the second layer 14, are subject to preferred light transmission values and coefficients of friction. More specifically, the composition of the subject invention, as described above, preferably has a light transmission value of at least 40%, as measured in accordance with ASTM D-1003, which is herein incorporated by reference in its entirety. The light transmission value of at least 40% is of particular importance in the pipeline repair industry. More specifically, during the process of repairing the pipelines, it frequently becomes necessary to visibly inspect the liner or, alternatively, the first layer 12 to verify that the monomers cover the whole first layer 12 and completely cure. The visual inspection must be performed through the sleeve 10 or, alternatively, the second layer 14, with a camera. As such, visual inspection is made possible when the composition has a light transmission value of at least 40%.

In terms of coefficients of friction, it is also preferred that the composition of the subject invention or, alternatively, the second layer 14, has a coefficient of friction of less than 1.5, more preferably less than 0.75, which is due to the presence of the MABS graft copolymer in the composition. Again, the coefficient of friction of less than 1.5 is of particular importance in the pipeline repair industry. To insert the sleeve 10 into the liner or, alternatively, to insert the article 110 including the first layer 12 and the second layer 14 into the pipeline, an eversion process is often used whereby the sleeve 10 or, alternatively, the second layer 14, is turned inside out during insertion. Thus, when the sleeve 10 is used, the sleeve 10 rubs against itself during the eversion process. When the article 110 including the first layer 12 and the second layer 14 is used, the second layer 14 either rubs against itself or against an inner wall of the pipeline during insertion. As such, compositions having a coefficient of friction above 1.5 make it extremely difficult to perform the eversion process.

For the method of making the composition of the subject invention, the TPU, the MABS graft copolymer, and any other additives are fed into a compounding device according the weight ranges set forth above. Preferably, the TPU and the MABS are mixed together prior to feeding the TPU and MABS into the compounding device; however, it is to be appreciated that the TPU and the MABS may be separately fed into the compounding device. To ensure sufficient mixing of the TPU and the MABS graft copolymer, the compounding device is preferably a twin-screw extruder, which mixes the TPU and the MABS graft copolymer more effectively than a single-screw extruder. However, it is to be appreciated that other compounding devices may be used, such as a single-screw extruder with an auxiliary mixing mechanism, so long as the compounding device can accomplish suitable mixing.

Once the TPU and the MABS graft copolymer are in the compounding device, the TPU and the MABS graft copolymer may be heated. Alternatively, it is to be appreciated that the TPU and the MABS may be heated outside of the compounding device, prior to feeding the TPU and the MABS into the compounding device. The TPU and the MABS graft copolymer are heated within a temperature range of from 250° F. to 450° F., more preferably from 350° F. to 400° F. The heating melts the TPU and the MABS graft copolymer and promotes compounding of the TPU and the MABS graft copolymer.

The TPU and the MABS graft copolymer are also mixed in the compounding device, preferably by the twin screws of the twin-screw extruder, to produce the composition of the subject invention. The mixing may occur concurrently with the start of heating of the TPU and the MABS graft copolymer, or may occur after heating has already begun. After the TPU and the MABS graft copolymer have been sufficiently mixed to produce the composition of the subject invention, the composition may be discharged from the compounding device. More specifically, the composition is preferably extruded by the twin-screw extruder, and pelletized or granulated upon discharge from the twin-screw extruder. Alternatively, the composition may be extruded as a sleeve 10, as shown in FIG. 1, or may be extruded as a sheet. The sheet may be rolled or laid on top of another layer of material, such as fabric, to produce the article 110 including the first layer 12 and the second layer 14 as described in detail above.

### EXAMPLES

A composition of the subject invention is made according a method of the subject invention, as set forth above. Specific components and amounts that may be used to produce the composition are set forth in Table 1 below, with all amounts in parts by weight based on the total weight of the composition unless otherwise stated.

TABLE 1

| Component | Ex. A | Ex. B | Ex. C |
|---|---|---|---|
| TPU A | 80.00 | 0.00 | 0.00 |
| TPU B | 0.00 | 80.00 | 0.00 |
| TPU C | 0.00 | 0.00 | 80.00 |
| MABS | 20.00 | 20.00 | 20.00 |
| Total | 100.00 | 100.00 | 100.00 |
| Coefficient of | 0.20 | 0.20 | 0.20 |
| Friction | | | |
| Light Transmission | >40% | >40% | >40% |
| Value | | | |

TPU A is polyester-based TPU having a hardness of about 85 Shore A commercially available under the trade name Elastollan® 685A50N from BASF Corporation;

TPU B is a polyester-based TPU having a hardness of about 88 Shore A commercially available under the trade name Elastollan® 688A50N from BASF Corporation;

TPU B is a polyether-based TPU having a hardness of about 85 Shore A commercially available under the trade name Elastollan® 1185A50V from BASF Corporation; and

MABS is commercially available under the trade name Terlux under the trade name Terlux® 2812 TR from BASF Corporation.

The invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A method of making a composition in a compounding device, said method comprising the steps of:
feeding thermoplastic polyurethane into the compounding device in an amount of greater than 40 parts by weight based on the total weight of the composition;
feeding methyl methacrylate-acrylonitrile-butadiene-styrene graft copolymer into the compounding device in an amount of from 1 to 50 parts by weight based on the total weight of the composition;
heating the thermoplastic polyurethane and the methyl methacrylate-acrylonitrile-butadiene-styrene graft copolymer; and
mixing the thermoplastic polyurethane and the methyl methacrylate-acrylonitrile-butadiene-styrene graft copolymer in the compounding device to produce the composition.

2. A method as set forth in claim 1 further comprising the step of mixing the thermoplastic polyurethane and the methyl methacrylate-acrylonitrile-butadiene-styrene graft copolymer prior to said steps of feeding the thermoplastic polyurethane and feeding the methyl methacrylate-acrylonitrile-butadiene-styrene graft copolymer into the compounding device.

3. A method as set forth in claim 1 wherein the thermoplastic polyurethane and the methyl methacrylate-acrylonitrile-butadiene-styrene graft copolymer are heated in the compounding device.

4. A method as set forth in claim 1 wherein the compounding device comprises a twin-screw extruder and the thermoplastic polyurethane and the methyl methacrylate-acrylonitrile-butadiene-styrene graft copolymer are mixed in the twin-screw extruder.

5. A method as set forth in claim 1 wherein the thermoplastic polyurethane and the methyl methacrylate-acrylonitrile-butadiene-styrene graft copolymer are heated within a temperature range of from 250° F. to 450° F.

6. A method as set forth in claim 1 comprising feeding the methyl methacrylate-acrylonitrile-butadiene-styrene graft copolymer into the compounding device in an amount of from 15 to 25 parts by weight based on the total weight of the composition.

7. A method as set forth in claim 1 further comprising the step of palletizing the composition.

8. A method as set forth in claim 1 further comprising the step of feeding a lubricant into the compounding device in an amount of from 0.05 to 1 parts by weight based on the total weight of the composition.

9. A composition comprising:
thermoplastic polyurethane present in an amount of greater than 40 parts by weight based on the total weight of said composition; and
methyl methacrylate-acrylonitrile-butadiene-styrene graft copolymer present in an amount of from 1 to 50 parts by weight based on the total weight of said composition.

10. A composition as set forth in claim 9 wherein said methyl methacrylate-acrylonitrile-butadiene-styrene graft copolymer is present in an amount of from 5 to 40 parts by weight based on the total weight of said composition.

11. A composition as set forth in claim 10 wherein said methyl-methacrylate-acrylonitrile-butadiene-styrene graft copolymer is present in an amount of from 15 to 25 parts by weight based on the total weight of said composition.

12. A composition as set forth in claim 9 wherein said thermoplastic polyurethane is selected from the group of polyester-based thermoplastic polyurethanes, polyether-based thermoplastic polyurethanes, and combinations thereof.

13. A composition as set forth in claim 9 wherein said thermoplastic polyurethane is present in an amount of from 75 to 94 parts by weight based on the total weight of said composition.

14. A composition as set forth in claim 9 having a light transmission value of at least 40% as measured in accordance with ASTM D-1003.

15. A composition as set forth in claim 9 having a coefficient of friction of less than 1.5.

16. A composition as set forth in claim 9 further comprising a lubricant in an amount of from 0.05 to 1 parts by weight based on the total weight of said composition.

17. An article formed from said composition of claim 9.

18. An article as set forth in claim 17 wherein said article is a sleeve (10).

19. An article (110) comprising:
a first layer (12) comprising an impregnable material;
a second layer (14) disposed upon said first layer (12) and having a light transmission value of at least 40% as measured in accordance with ASTM D-1003 and a coefficient of friction of less than 1.5, said second layer (14) comprising:
thermoplastic polyurethane; and
a copolymer comprising styrene for reducing the coefficient of friction of said thermoplastic polyurethane.

20. An article (110) as set forth in claim 19 wherein said copolymer comprises methyl methacrylate-acrylonitrile-butadiene-styrene graft copolymer.

21. An article (110) as set forth in claim 19 wherein said copolymer is present in an amount of from 1 to 50 parts by weight based on the total weight of said second layer (14).

22. An article (110) as set forth in claim 21 wherein said copolymer is present in an amount of from 15 to 25 parts by weight based on the total weight of said second layer (14).

23. An article (110) as set forth in claim 21 wherein said thermoplastic polyurethane is present in said second layer (14) in an amount of greater than 40 parts by weight based on the total weight of said second layer (14).

24. An article (110) as set forth in claim 19 wherein said impregnable material is selected from the group of fabric, foam, and combinations thereof.

25. An article (110) as set forth in claim 24 wherein said fabric comprises non-woven fabric.

26. An article (110) as set forth in claim 19 wherein said first layer (12) has a thickness of from 0.1 to 0.5 inches.

27. An article (110) as set forth in claim 19 wherein said second layer (14) has a thickness of from 0.001 to 0.150 inches.
